(19) United States
(12) Patent Application Publication
(10) Pub. No.: US 2018/0044221 A1
(43) Pub. Date: Feb. 15, 2018

(54) METHOD AND APPARATUS FOR PRODUCING OPTICAL FIBER PREFORM

(71) Applicant: Shin-Etsu Chemical Co., Ltd., Tokyo (JP)

(72) Inventors: Hiroki KOJIMA, Kamisu (JP); Makoto YOSHIDA, Takasaki (JP)

(21) Appl. No.: 15/668,671

(22) Filed: Aug. 3, 2017

(30) Foreign Application Priority Data
Aug. 9, 2016 (JP) 2016-156518

(51) Int. Cl. C03B 37/014

(52) U.S. Cl. CPC C03B 37/0142; C03B 37/014

(57) ABSTRACT

A method for producing an optical fiber includes stabilizing a burner flame using a multi-nozzle burner. The multi-nozzle burner includes a raw material gas ejection port in a central part for ejecting a raw material gas. The multi-nozzle burner includes a seal gas ejection port on an outer side of the raw material gas ejection port for ejecting a seal gas. The multi-nozzle burner includes a combustible gas ejection port on an outer side of the seal gas ejection port for ejecting a combustible gas. The multi-nozzle burner includes a plurality of small diameter combustion supporting gas ejection ports surrounding the seal gas ejection port in the combustible gas ejection port for ejecting a combustion supporting gas. A gas flow rate of the raw material gas ejection port is V1 and a gas flow rate of the seal gas ejection port is V2, and 1>V2/V1>0.05.

### CROSS-REFERENCE TO RELATED APPLICATION

This non-provisional application claims priority under 35 U.S.C. §119(a) from Japanese Patent Application No. 2016-156518, filed on Aug. 9, 2016, the entire contents of which are incorporated herein by reference.

### BACKGROUND

### Technical Field

The present invention relates to a method and apparatus for producing an optical fiber preform which stabilizes a burner flame to allow a high quality large-sized preform to be produced at a low burner load.

### Background Art

In a VAD method, which is a well-known method for producing an optical fiber preform, a starting material is attached to a shaft which moves upward while rotating, and hung in a reaction chamber. Glass fine particles produced by a core deposition burner and clad deposition burner set at a predetermined angle with respect to the axial direction of the starting material in the reaction chamber are adhered and deposited on the tip of the starting material to produce a porous glass preform including a core layer and a cladding layer. The VAD method is suitable for growing the preform in size and for producing a low water peak fiber (LWPF).

FIG. 1 schematically shows an optical fiber preform producing apparatus 100 according to a VAD method. The optical fiber preform producing apparatus 100 includes a reaction vessel 110, a core deposition burner 121, a first clad deposition burner 122, and a second clad deposition burner 123.

The reaction vessel 110 includes a deposition chamber 111, and an intake port 111a and exhaust port 111b formed in the deposition chamber 111. A starting material (not shown) is inserted into the deposition chamber 111. A core deposition burner 121 is disposed at a predetermined angle with respect to the pulling axis of the starting material toward the tip of the starting material. A first clad deposition burner 122 and a second clad deposition burner 123 are disposed at a predetermined angle with respect to the pulling axis of the starting material toward the side surface of the starting material.

The starting material is made to move upward while being rotated, and a reaction gas was supplied to each burner and hydrolyzed in an oxyhydrogen flame, to synthesize glass fine particles. The glass fine particles are sprayed onto the starting material and deposited to produce a porous glass preform 10. The produced porous glass preform 10 is dehydrated and transparently vitrified in an electric furnace (not shown), thereby providing a preform for optical fiber.

For each burner of such a producing apparatus, a concentric multiple tube burner made of quartz glass has been generally used. However, in the burner having a concentric multiple tube structure, a glass raw material gas, a combustible gas, and a combustion supporting gas are insufficiently mixed, which provides insufficient production of glass fine particles. This causes poor deposition efficiency, which makes it difficult to produce the preform at a high speed.

As the structure of each port outlet of a burner for solving this problem, a multi-nozzle burner 120 having a structure as shown in FIG. 2 is disclosed in JP 2010-215415 A. The multi-nozzle burner 120 includes a small diameter combustion supporting gas ejection port disposed in a combustible gas ejection port so as to surround a raw material gas ejection port located at the central part of the combustible gas ejection port. The multi-nozzle burner 120 includes a raw material gas ejection port 120a provided in a central part and ejecting a raw material gas, a first seal gas ejection port 120b annularly provided on the concentric outer side of the raw material gas ejection port 120a and ejecting a seal gas, a combustible gas ejection port 120c annularly provided on the concentric outer side of the first seal gas ejection port 120b and ejecting a combustible gas, a plurality of small diameter combustion supporting gas ejection ports 120d provided so as to surround the first seal gas ejection port 120b in the combustible gas ejection port 120c and ejecting a combustion supporting gas, a second seal gas ejection port 120e annularly provided on the concentric outer side of the combustible gas ejection port 120c and ejecting a seal gas, and a combustion supporting gas ejection port 120f annularly provided on the concentric outer side of the second seal gas ejection port 120e and ejecting a combustion supporting gas.

### SUMMARY OF THE INVENTION

### Problems to be Solved by the Invention

In recent years, as a preform is grown in size for the purpose of cost reduction, the feed rate of a gas to a burner is increased, the life time of the burner is shortened by the fixing of glass fine particles to the burner, and the cracking of the preform due to the instability of a burner flame, and the variation of the diameter of the preform are aggravated.

An object of the present invention is to provide a method and apparatus for producing an optical fiber preform which stabilizes a burner flame to allow a high quality large-sized preform to be produced at a low burner load.

### Means for Solving the Problems

A method for producing an optical fiber preform of the present invention using a multi-nozzle burner,

the multi-nozzle burner including:

a raw material gas ejection port provided in a central part and ejecting a raw material gas;

a seal gas ejection port annularly provided concentrically on an outer side of the raw material gas ejection port and ejecting a seal gas;

a combustible gas ejection port annularly provided concentrically on an outer side of the seal gas ejection port and ejecting a combustible gas; and

a plurality of small diameter combustion supporting gas ejection ports provided so as to surround the seal gas ejection port in the combustible gas ejection port and ejecting a combustion supporting gas,

wherein when a gas flow rate of the raw material gas ejection port is V1 and a gas flow rate of the seal gas ejection port is V2, the gas flow rates are controlled so that 1>V2/V1>0.05 is set.

An apparatus for producing an optical fiber preform of the present invention,

the apparatus including a multi-nozzle burner,

the multi-nozzle burner including:

a raw material gas ejection port provided in a central part and ejecting a raw material gas;

a seal gas ejection port annularly provided concentrically on an outer side of the raw material gas ejection port and ejecting a seal gas;

a combustible gas ejection port annularly provided concentrically on an outer side of the seal gas ejection port and ejecting a combustible gas; and

a plurality of small diameter combustion supporting gas ejection ports provided so as to surround the seal gas ejection port in the combustible gas ejection port and ejecting a combustion supporting gas,

wherein when a gas flow rate of the raw material gas ejection port is V1 and a gas flow rate of the seal gas ejection port is V2, the gas flow rates are controlled so that 1>V2/V1>0.05 is set.

The method and apparatus for producing an optical fiber preform of the present invention optimize the flow rate ratio between the gas flow rate of the raw material gas ejection port and the gas flow rate of the seal gas ejection port to provide difficult fixing of the glass fine particles to the burner, and to stabilize a burner flame, thereby allowing a high quality large-sized preform to be produced at a low burner load.

### BRIEF DESCRIPTION OF THE DRAWINGS

FIG. 1 schematically shows an apparatus for producing an optical fiber preform according to a VAD method; and

FIG. 2 shows an example of a multi-nozzle burner used in a method and apparatus for producing an optical fiber preform according to the present invention.

### DETAILED DESCRIPTION OF THE EMBODIMENTS

Hereinafter, embodiments of the present invention will be described.

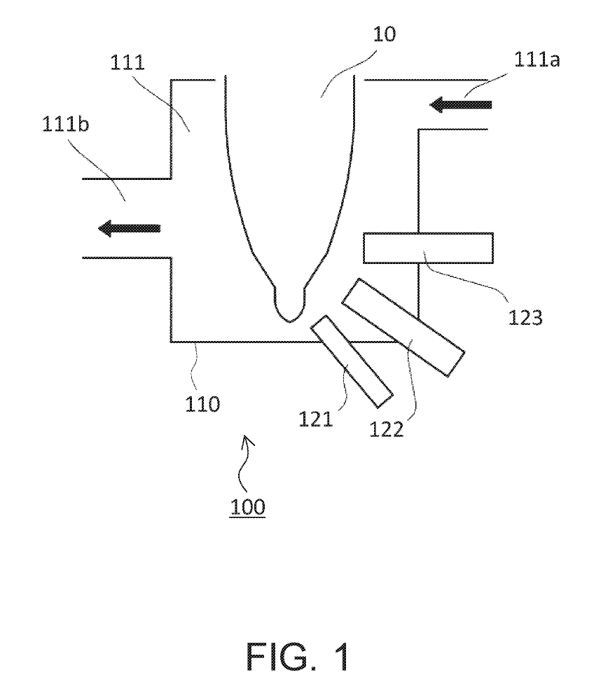

FIG. 1 shows an optical fiber preform producing apparatus 100 used for carrying out a method for producing an optical fiber preform according to the present invention. The optical fiber preform producing apparatus 100 includes a reaction vessel 110, a core deposition burner 121, a first clad deposition burner 122, and a second clad deposition burner 123.

The reaction vessel 110 includes a deposition chamber 111, and an intake port 111a and exhaust port 111b formed in the deposition chamber 111. A starting material (not shown) is inserted into the deposition chamber 111. A core deposition burner 121 is disposed at a predetermined angle with respect to the pulling axis of the starting material toward the tip of the starting material. A first clad deposition burner 122 and a second clad deposition burner 123 are disposed at a predetermined angle with respect to the pulling axis of the starting material toward the side surface of the starting material.

All the burners are generally made of quartz glass, and a seal gas ejection port is provided on the concentric outer side of a raw material gas ejection port provided in a central part. Raw material gas of glass fine particles, Ar and O₂ are ejected from the raw material gas ejection port, but in the present specification, they are collectively referred to as a raw material gas.

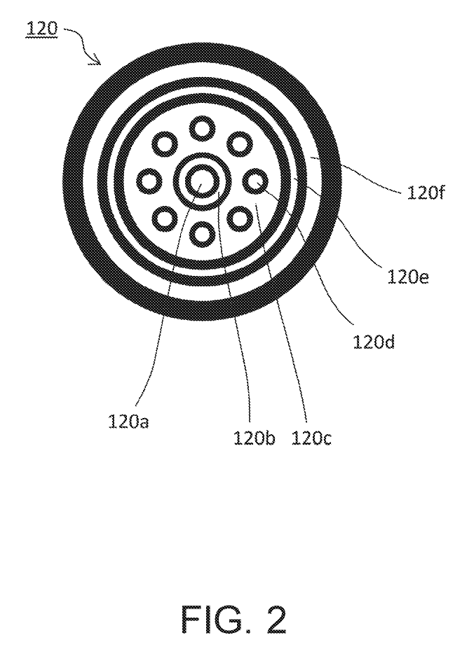

To the core deposition burner 121, for example, a concentric four-tube burner is applied, and a raw material gas (for example, SiCl₄, O₂), a combustible gas (for example, H₂), a combustion supporting gas (for example, O₂), and a seal gas (for example, N₂) are supplied. To the first clad deposition burner 122 and the second clad deposition burner 123, a multi-nozzle burner 120 as shown in FIG. 2 is applied.

The multi-nozzle burner 120 includes a raw material gas ejection port 120a provided in a central part and ejecting a raw material gas (for example, SiCl₄, O₂), a first seal gas ejection port 120b annularly provided on the concentric outer side of the raw material gas ejection port 120a and ejecting a seal gas (for example, N₂), a combustible gas ejection port 120c annularly provided on the concentric outer side of the first seal gas ejection port 120b and ejecting a combustible gas (for example, H₂), a plurality of small diameter combustion supporting gas ejection ports 120d provided so as to surround the first seal gas ejection port 120b in the combustible gas ejection port 120c and ejecting a combustion supporting gas (for example, O₂), a second seal gas ejection port 120e annularly provided on the concentric outer side of the combustible gas ejection port 120c and ejecting a seal gas, and a combustion supporting gas ejection port 120f annularly provided on the concentric outer side of the second seal gas ejection port 120e and ejecting a combustion supporting gas.

In the case of the concentric multi-tube burner, the degree of mixing of the combustible gas forming a burner flame with the combustion supporting gas is largely influenced by the relationship between the gas flow rate of the combustible gas and the gas flow rate of the combustion supporting gas. Therefore, when the raw material gas is reacted with the combustible gas and combustion supporting gas separated by a seal gas, the simple control of the relationship between the gas flow rate of the raw material gas and the gas flow rate of the seal gas does not allow the control of the reaction of the raw material gas with the combustible gas and the combustion supporting gas to be completed. On the other hand, in the case of the multi-nozzle burner in which the plurality of small diameter combustion supporting gas ejection ports are provided in the combustible gas ejection port, the combustible gas and the combustion supporting gas are stably and sufficiently mixed. Therefore, the control of the relationship between the gas flow rate of the raw material gas and the gas flow rate of the first seal gas completes the control of the reaction among the raw material gas, the combustible gas, and the combustion supporting gas to allow both the gases to be reacted at an appropriate position.

Then, in the method for producing an optical fiber preform according to the present invention, when the gas flow rate of the raw material gas ejection port 120a is V1 and the gas flow rate of the first seal gas ejection port 120b provided on the concentric outer side thereof is V2, the flow rates are controlled so as to satisfy 1>V2/V1>0.05. Therefore, the flow rate ratio between the gas flow rate of the raw material gas ejection port and the gas flow rate of the seal gas ejection port is optimized, which allows the raw material gas, the combustible gas and the combustion supporting gas to react with each other at an appropriate position. This causes difficult fixing of the glass fine particles to the burner, and stabilizes the burner flame, which makes it possible to produce a high quality large-sized preform at a low burner load.

In particular, since the first clad deposition burner 122 generally has a lower raw material gas feed rate than that of the second clad deposition burner 123, the raw material gas has poor straight-running stability. Therefore, by adopting the method of the present invention for at least the first clad deposition burner 122, the straight-running stability of the raw material gas is improved, which largely contributes to prevention of occurrences of preform cracking and variation of a preform diameter.

When 1<V2/V1 is set, the flow rate of the seal gas is higher than the flow rate of the raw material gas, and the raw material gas on the concentric inner side of the seal gas and the combustible gas and combustion supporting gas on the concentric outer side of the seal gas react with each other at a point more distant from the tip of the burner. Therefore, the burner flame becomes unstable, which causes problems such as preform cracking and variation of a preform diameter.

When V2/V1<0.05 is set, the raw material gas, the combustible gas, and the combustion supporting gas react in the vicinity of the tip of the burner, which causes the fixing of the glass fine particles to the burner and the burning of the burner. In such a case, the burner is damaged or blocked, which makes it necessary to discard the burner and replace the burner with a new burner.

It should be noted that the present invention is not limited to the above embodiment. The above embodiment is just an example, and any examples that have substantially the same configuration and exhibit the same functions and effects as the technical concept described in claims according to the present invention are included in the technical scope of the present invention.

### EXAMPLES

By a VAD method, a porous glass preform 10 was produced using an optical fiber preform producing apparatus 100 shown in FIG. 1. As a core deposition burner 121, a concentric four-tube burner was used, and appropriate amounts of a raw material gas (SiCl₄, O₂), combustible gas, combustion supporting gas, and seal gas were supplied. As shown in FIG. 2, for a first clad deposition burner 122 and a second clad deposition burner 123, a multi-nozzle burner 120 having a nozzle focal length of 100 mm was used. The multi-nozzle burner 120 included eight small diameter combustion supporting gas ejection ports 120d having the same diameter and provided at equal intervals so as to surround a first seal gas ejection port 120b in a combustible gas ejection port 120c. Here, the raw material gas (SiCl₄, O₂), the combustible gas, the combustion supporting gas, the first seal gas, and the second seal gas were supplied to the first clad deposition burner 122 in a state where the flow rate ratio V2/V1 of the gas flow rate V1 of the raw material gas ejection port 120a to the gas flow rate V2 of the first seal gas ejection port 120b was adjusted by changing only the flow rate of the first seal gas as shown in Table 1 among the raw material gas (SiCl₄, O₂), the combustible gas, the combustion supporting gas, the first seal gas, and the second seal gas. The flow rate was varied by changing the feed rate of the seal gas. As the second clad deposition burner 123, suitable amounts of the raw material gas (SiCl₄, O₂), combustible gas, combustion supporting gas, first seal gas, and second seal gas were supplied. A deposition time is 24 hours. Next, sintering vitrification was carried out to produce 10 transparent glass preforms. Table 1 shows the deposition conditions due to the first clad deposition burner 122 and the production results of the transparent glass preform.

TABLE 1

| | | | | | | | Comparative | Comparative |
|---|---|---|---|---|---|---|---|---|
| | | | Example 1 | Example 2 | Example 3 | Example 4 | Example 1 | Example 2 |
| Gas flow | Gas ejection port | Gas | | | | | | |
| rate (m/s) | Raw material (V1) | SiCl₄ | 4.71 | 4.71 | 4.71 | 4.71 | 4.71 | 4.71 |
| | SiCl4:O2 = 1:1 | O₂ | | | | | | |
| | First seal (V2) | N₂ | 4.24 | 3.20 | 2.12 | 1.08 | 5.32 | 0.24 |
| | Combustible | H₂ | 1.8 | 1.8 | 1.8 | 1.8 | 1.8 | 1.8 |
| | Small diameter | O₂ | 10.6 | 10.6 | 10.6 | 10.6 | 10.6 | 10.6 |
| | combustion support | | | | | | | |
| | Second seal | N₂ | 1.0 | 1.0 | 1.0 | 1.0 | 1.0 | 1.0 |
| | Combustion support | O₂ | 1.0 | 1.0 | 1.0 | 1.0 | 1.0 | 1.0 |

| | | | | | | |
|---|---|---|---|---|---|---|
| Gas flow rate ratio V2/V1 | 0.90 | 0.68 | 0.45 | 0.23 | 1.13 | 0.05 |
| Production number | 10 | 10 | 10 | 10 | 10 | 10 |
| Preform cracking, Number | 0 | 0 | 0 | 0 | 4 | 0 |
| Variation of preform diameter, Number | 0 | 0 | 0 | 0 | 5 | 0 |
| Production number until burner blocking | No blocking | No blocking | No blocking | No blocking | No blocking | 7 |

In the case of Comparative Example 1, the flow rate of the first seal gas was high and the reaction between the raw material gas and an oxyhydrogen flame occurred at a point distant from the tip of the burner, which caused an unstable burner flame, and the pulsation of the flame was observed. As a result, preform cracking and variation of a preform diameter occurred. In the case of Comparative Example 2, the flow rate of the seal gas was slow, and the reaction between the raw material gas and the oxyhydrogen flame occurred in the vicinity of the tip of the burner, so that the produced glass fine particles were fixed to the burner, to cause the burner to be clogged and become unusable. On the other hand, in the case of Examples 1 to 4 in which the flow rate of the first seal gas was adjusted so that the flow rate ratio V2/V1 of the flow rate V1 of the raw material gas to the flow rate V2 of the seal gas was set to 1>V2/V1>0.05, the burner flame was stable and no preform cracking occurred. Furthermore, after ten preforms were produced, the glass fine particles were not fixed to the burners, and thereafter the burners could be used without problems.

What is claimed is:

1. A method for producing an optical fiber preform using a multi-nozzle burner,
the multi-nozzle burner comprising:
a raw material gas ejection port provided in a central part and ejecting a raw material gas;
a seal gas ejection port annularly provided concentrically on an outer side of the raw material gas ejection port and ejecting a seal gas;
a combustible gas ejection port annularly provided concentrically on an outer side of the seal gas ejection port and ejecting a combustible gas; and
a plurality of small diameter combustion supporting gas ejection ports provided so as to surround the seal gas ejection port in the combustible gas ejection port and ejecting a combustion supporting gas,
wherein, when a gas flow rate of the raw material gas ejection port is V1 and a gas flow rate of the seal gas ejection port is V2, the gas flow rates are controlled so that 1>V2/V1>0.05 is set.

2. An apparatus for producing an optical fiber preform,
the apparatus comprising a multi-nozzle burner,
the multi-nozzle burner including:
a raw material gas ejection port provided in a central part and ejecting a raw material gas;
a seal gas ejection port annularly provided concentrically on an outer side of the raw material gas ejection port and ejecting a seal gas;
a combustible gas ejection port annularly provided concentrically on an outer side of the seal gas ejection port and ejecting a combustible gas; and
a plurality of small diameter combustion supporting gas ejection ports provided so as to surround the seal gas ejection port in the combustible gas ejection port and ejecting a combustion supporting gas,
wherein, when a gas flow rate of the raw material gas ejection port is V1 and a gas flow rate of the seal gas ejection port is V2, the gas flow rates are controlled so that 1>V2/V1>0.05 is set.
